(19) United States
(12) Patent Application Publication
(10) Pub. No.: US 2011/0175570 A1
(43) Pub. Date: Jul. 21, 2011

(54) Electrical Outlet Cover For Charging Electrified Vehicles

(75) Inventor: Marc Jonathon Lucas, Novi, MI (US)

(73) Assignee: FORD GLOBAL TECHNOLOGIES, LLC, Dearborn, MI (US)

(21) Appl. No.: 12/786,891

(22) Filed: May 25, 2010

(51) Int. Cl. H02J 7/00; H02G 3/14

(52) U.S. Cl. 320/109; 174/66

(57) ABSTRACT

To ensure that a plug for a charge cord set of an electric vehicle does not fall out or is inadvertently bumped causing it to decouple from the outlet, a wall outlet cover that supports and secures a charge cord set is disclosed. In one embodiment, the outlet cover has an integral trough into which an EVSE of the charge cord set is placed, thereby reducing the weight of the charge cord set acting on the plug of the charge cord set. In another embodiment, a support feature is included on the outlet cover and a mating support feature provided on the EVSE, in one example, a hook and loop.

### BACKGROUND

1. Technical Field

The present disclosure relates generally to an electrical outlet cover having a feature to support a charge cord set for an electric vehicle.

2. Background Art

Battery electric and plug in hybrid vehicles can be charged at any time of the day or night by plugging a charge cord set between an electrical outlet and the vehicle. To carry the current as demanded by the recharging system the charge cord cross sectional area is relatively large and due to the long length of cable gives a cord set of notable mass. Furthermore, the charge cord set includes an electric vehicle supply equipment (EVSE) module, which performs various functions as described below. Sometimes the weight of the cord and the EVSE causes the end of the plug coupled to the wall outlet to decouple. Furthermore, when the cord and EVSE are acting to pull out the plug due to their weight, the plug is easily dislodged by a person or animal, such as a pet, interfering with the cord. As the driving range of the electric vehicle depends on the battery state of charge, such an inadvertent decoupling of the cord may prevent the vehicle operator from being able to drive their vehicle the desired distance.

### SUMMARY

A charge cord set and wall outlet system for recharging an electric vehicle is disclosed that has a first cord with a coupler adapted to couple with a receptacle on the vehicle, a second cord having a plug end which couples to a wall outlet, and an EVSE located between the first and second cords. The wall outlet system further includes an outlet cover coupled to the wall outlet, with the outlet cover having an integral support feature supporting the EVSE. In one embodiment, the support feature comprises a square-bottomed trough located at the bottom of the outlet cover as installed, and an open side of the trough faces upwardly when the outlet cover is installed. A longitudinal axis of the trough is roughly parallel to the outlet cover and an opening size of the trough perpendicular with the longitudinal axis is determined so that it cooperates with the EVSE. The EVSE is nominally cuboid with one dimension of the EVSE being nominally equal to an opening of the trough. In one embodiment, the EVSE cooperates with the trough in a snap-fit arrangement.

In one embodiment, the EVSE has a support feature which mates with the integral support feature of the outlet cover. The integral support feature comprises a hook and the EVSE support feature comprises a loop. Alternatively, the integral support feature comprises a loop and the EVSE support feature comprises a hook. In some embodiments, the first end of the cord has a plug with prongs and the cord coupled to the plug extends from the plug roughly perpendicular with respect to a direction at which the prongs extend from the plug. In some embodiments, the charge cord set has a length of cord between the EVSE and the first plug that is greater than a distance between a standard height of the wall outlet from the floor.

In one embodiment, an outlet cover for a wall outlet has a plate having two outlet apertures, one fastener aperture, and a roughly square-bottomed trough located at a lower end of the plate as installed. The trough is integral with the plate. The cover is comprised of a plastic material, a metallic material, or other suitable material.

In another embodiment, an outlet cover for a wall outlet adapted to couple with a charge cord set of an electric vehicle has a plate having two outlet apertures, one fastener aperture, and a cord support feature. The cord support feature comprises a trough located at a lower of the outlet cover as installed. The trough is integral with the outlet cover. A longitudinal axis of the trough is roughly parallel to the plate and perpendicular to gravity as installed on a wall outlet.

### BRIEF DESCRIPTION OF THE DRAWINGS

FIG. 1 is a sketch of an embodiment of a charge cord set coupled between an electric vehicle and a wall outlet with an outlet cover mounted to the wall outlet;

FIG. 2 is a detail of one embodiment of the plug of the charge cord set; and

FIG. 3 shows one embodiment of the wall outlet cover and the EVSE portion of the charge cord set.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations consistent with the present disclosure, e.g., ones in which components are arranged in a slightly different order than shown in the embodiments in the Figures. Those of ordinary skill in the art will recognize that the teachings of the present disclosure may be applied to other applications or implementations.

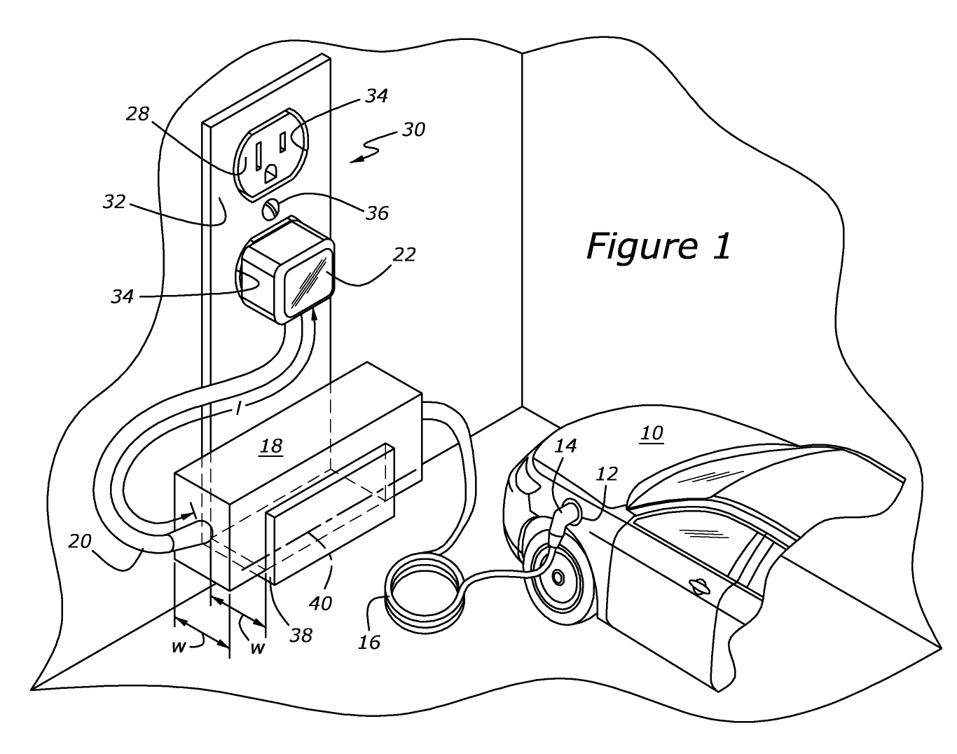

In FIG. 1, an electric vehicle 10 having a receptacle 12 is coupled to a charging charge cord set. The charging charge cord set includes a first end 14, i.e., a coupler which couples to receptacle 12; a first length of cord 16; an EVSE (electric vehicle supply equipment) 18; a second length of cord 20, and a second end 22, i.e., a plug for coupling with an electrical outlet. Also shown in FIG. 1 are wall outlets or receptacles 28. An outlet cover 30 is mounted over receptacles 28. Outlet cover 30 has: two outlet apertures 34 to accommodate receptacles 28; one fastener outlet 36 through which a fastener, such as a screw, is used to mount outlet cover 30 to the wall. Outlet cover 30 has a plate portion 32 and a trough portion 38 with the opening of the trough pointing upwardly. A longitudinal axis 40 of trough 38 is roughly parallel to the wall and roughly perpendicular to gravity. In the embodiment shown in FIG. 1, EVSE 18 is cuboid with cords 10 and 16 extending out from the long dimension of EVSE 18. The narrowest dimension is its width, w. Trough 38 is roughly the same width, w, wide. In one embodiment, outlet cover 30 is made of a plastic material and is sized to snap around EVSE 18 when placed in trough 38. Alternatively, outlet cover 30 is made of a metallic material, ceramic material, or other suitable material. The embodiment in FIG. 1 shows the EVSE as a rectangular cuboid. However, such configuration is not intended to be limiting. For example, EVSE could be cylindrical with the trough of the outlet cover being rounded at the bottom to accept the cylindrical body of the EVSE. The EVSE can be of any shape. FIG. 1 is not made to scale to support the purpose of illustrating the various features in a single drawing.

In some embodiments, EVSE includes fuses, relays, transformers, and a circuit board with processing capability. EVSE may communicate with a charger onboard the vehicle. EVSE 18 may include LEDs to indicate: charging occurring, a charging system fault, and charging complete, as examples. The EVSE 18 is sometimes alternatively called a GFCI (ground fault circuit interrupt) indicating another function which may be included in EVSE 18.

By providing support to an element of the charge cord set, namely the EVSE, the amount of force exerted on the plug attached to the wall outlet is greatly reduced, thereby reducing the possibility of inadvertent decoupling. Another advantage of the present disclosure is that there is no need to drill holes in the wall, insert wall plugs, hooks, etc. Removing one small screw allows removal of the standard wall plate and the electrical outlet cover according to the present disclosure is installed by replacing the one small screw, a task which can be accomplished by most individuals, i.e., obviating the need for special do-it-yourself skills.

In one embodiment, the electric vehicle is an electric-only vehicle. In other embodiments, the electric vehicle has another propulsion device beyond an electric motor, such as an internal combustion engine, as in a hybrid electric vehicle (HEV). Such HEVs can be plug-in HEVs to which the present disclosure also applies. Some electric vehicles have electrical generation on board, such as fuel-cell or free piston engines. In such cases, the electrical power in an onboard battery can be supplemented by plugging into the electrical grid. The present disclosure applies to such vehicles as well.

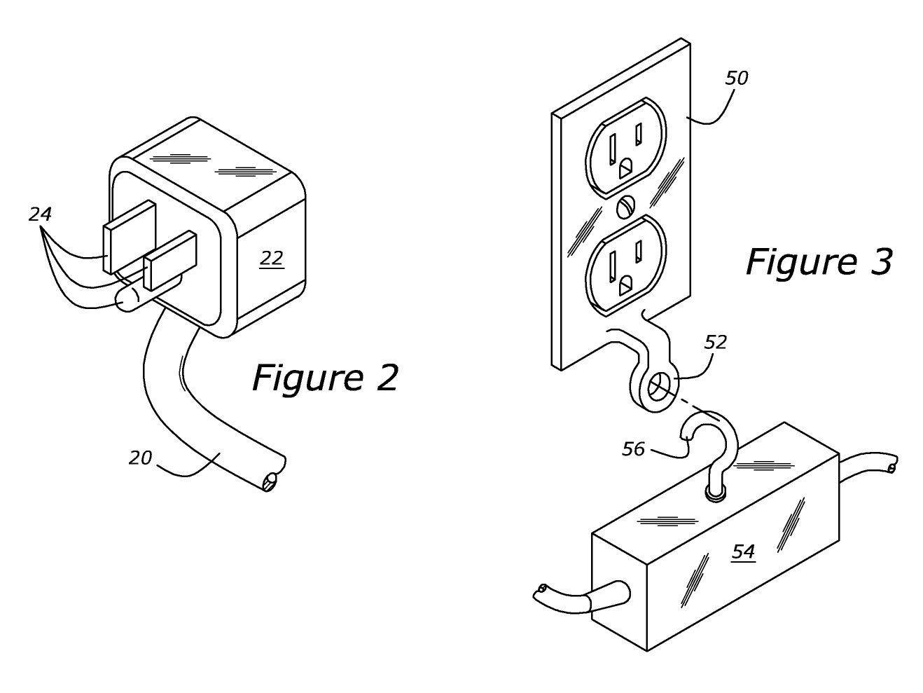

In FIG. 2, plug 22 has prongs 24 extending out one face of plug 22 with cord 20 extending out from plug 22 in a direction perpendicular in relation to prongs 24. Such an arrangement causes cord 20 and EVSE 18 to act more directly downward rather than having a component of the force acting to pulls plug 22 out from the wall outlet.

In FIG. 3, an alternative embodiment has an outlet cover 50 with an integral support feature 52, in this case a loop. AN EVSE 54, which is part of a charge cord set, has a support feature 56, which in this case is a hook. This is one non-limiting example, any suitable combination can be used in place of the hook and loop.

While the best mode has been described in detail, those familiar with the art will recognize various alternative designs and embodiments within the scope of the following claims. Where one or more embodiments have been described as providing advantages or being preferred over other embodiments and/or over prior art in regard to one or more desired characteristics, one of ordinary skill in the art will recognize that compromises may be made among various features to achieve desired system attributes, which may depend on the specific application or implementation. These attributes include, but are not limited to: cost, strength, durability, life cycle cost, marketability, appearance, packaging, size, serviceability, weight, manufacturability, ease of assembly, etc. The embodiments described as being less desirable relative to other embodiments with respect to one or more characteristics are not outside the scope of the disclosure as claimed.

What is claimed:

1. A charge cord set and wall outlet system for recharging an electric vehicle, the cord set comprising:
a first cord having a coupler;
a second cord having a plug end which couples to a wall outlet; and
an electric vehicle supply equipment (EVSE) located between the first and second cords wherein the wall outlet system comprises: an electrical outlet cover coupled to the wall outlet, the electrical outlet cover having an integral support feature supporting the EVSE.

2. The charge cord set and wall outlet system of claim 1 wherein the support feature comprises a square-bottomed trough located at the bottom of the electrical outlet cover as installed, and an open side of the trough faces upwardly when the electrical outlet cover is installed.

3. The charge cord set and wall outlet system of claim 2 wherein a longitudinal axis of the trough is roughly parallel to a plate portion of the electrical outlet cover and an opening size of the trough perpendicular with the longitudinal axis is sized to cooperate with the EVSE.

4. The charge cord set and wall outlet system of claim 2 wherein the EVSE is nominally cuboid with one dimension of the EVSE being nominally equal to an opening of the trough.

5. The charge cord set and wall outlet system of claim 4 wherein the EVSE snaps into the trough.

6. The charge cord set and wall outlet system of claim 1, further comprising:
an EVSE support feature coupled to the EVSE wherein the EVSE support feature mates with the integral support feature of the electrical outlet cover.

7. The charge cord set and wall outlet system of claim 6 wherein the integral support feature comprises a hook and the EVSE support feature comprises a loop.

8. The charge cord set and wall outlet system of claim 6 wherein the integral support feature comprises a loop and the EVSE support feature comprises a hook.

9. The charge cord set and wall outlet system of claim 1 wherein the plug end comprises a plug with prongs, the second cord coupled to the plug extends from the plug roughly perpendicular with respect to a direction at which the prongs extend from the plug, and the coupler is adapted to couple to a receptacle onboard the electric vehicle.

10. An electrical electrical outlet cover for a wall outlet, the cover comprising:
a plate having two outlet apertures, one fastener aperture, and a roughly square-bottomed trough located at a lower end of the plate as installed.

11. The electrical outlet cover of claim 10 wherein the trough is integral with the plate.

12. The electrical outlet cover of claim 10 wherein the cover is comprised of a plastic material.

13. The electrical outlet cover of claim 10 wherein the cover is comprised of one of a metallic and ceramic material.

14. An electrical outlet cover for a wall outlet adapted to couple with a charge cord set of an electric vehicle, the cover comprising:
a plate having two outlet apertures, one fastener aperture, and a cord support feature.

15. The electrical outlet cover of claim 14 wherein the cord support feature comprises a trough located at a lower of the electrical outlet cover as installed.

16. The electrical outlet cover of claim 14 wherein the trough is integral with the electrical outlet cover.

17. The electrical outlet cover of claim 16 wherein a longitudinal axis of the trough is roughly parallel to the plate and perpendicular to gravity as installed on a wall outlet.

18. The electrical outlet cover of claim 17 wherein the trough is one of square bottomed or round bottomed.

19. The electrical outlet cover of claim 14 wherein the cord support feature is provided to mate with a feature on the charge cord set and the cord support feature comprises one of a hook and a loop.

20. The electrical outlet cover of claim 14 wherein the electrical outlet cover is comprised of one of metal, plastic, and ceramic.
